(19) United States
(12) Patent Application Publication
(10) Pub. No.: US 2019/0294097 A1
(43) Pub. Date: Sep. 26, 2019

(54) IMAGE FORMING APPARATUS AND IMAGE FORMING METHOD

(71) Applicant: TOSHIBA TEC KABUSHIKI KAISHA, Tokyo (JP)

(72) Inventor: Toshihiko ASAHI, Suntou Shizuoka (JP)

(21) Appl. No.: 16/276,116

(22) Filed: Feb. 14, 2019

(30) Foreign Application Priority Data
Mar. 26, 2018 (JP) 2018-058357

(51) Int. Cl. G03G 15/00

(52) U.S. Cl. CPC G03G 15/5062

(57) ABSTRACT

An image forming apparatus includes a storage device, an input device, and a processor. The storage device prestores first size information indicating a prescribed size of a first sheet and margin information indicating a margin region provided in the first sheet. The processor determines, on the basis of the first size information and the second size information, the image forming condition for forming the margin region indicated by the margin information on the second sheet.

### CROSS-REFERENCE TO RELATED APPLICATION

This application is based upon and claims the benefit of priority from the prior Japanese Patent Application No. 2018-058357, filed on Mar. 26, 2018, the entire contents of which are incorporated herein by reference.

### FIELD

An embodiment described here generally relates to an image forming apparatus and an image forming method.

### BACKGROUND

Conventionally, initial setting is performed on an image forming apparatus in a manufacturing process and in installation in a market where the image forming apparatus is actually used. However, in the manufacturing process and the market, even with sheets of the same standard size, the size of the sheet used in the manufacturing process and the size of the sheet to be used at the time of printing in the market differ from each other in some cases due to external factors such as humidity. In such cases, a margin different from a margin prescribed in the manufacturing process can be formed at the time of printing in the market.

### BRIEF DESCRIPTION OF THE DRAWINGS

FIG. 1 is an outer appearance view of an entire configuration example of an image forming apparatus according to an embodiment.

FIG. 2 is a block diagram schematically showing a configuration of functional blocks of the image forming apparatus according to the embodiment.

FIG. 3 is a diagram showing a data configuration of a sheet size table to be stored in a storage device according to the embodiment.

FIG. 4 is a diagram showing a prescribed size of a margin to be formed in image formation of a first sheet according to the embodiment.

FIG. 5 is a diagram showing a size of a margin to be formed in image formation of a second sheet according to the embodiment.

FIG. 6 is a diagram showing an image formed by correcting a reference position at which image formation is to be started in image formation on the second sheet according to the embodiment.

FIG. 7 is a diagram showing an image formed by correcting a scaling factor in a main scan direction in image formation on the second sheet according to the embodiment.

FIG. 8 is a diagram showing an image formed by correcting a scaling factor in a sub-scan direction in image formation on the second sheet according to the embodiment.

FIG. 9 is a flowchart showing a specific example of processing of the image forming apparatus according to the embodiment.

FIG. 10 is a flowchart showing a specific example of processing of the image forming apparatus according to the embodiment.

### DETAILED DESCRIPTION

In accordance with one embodiment, an image forming apparatus includes an image forming device, a storage device, an input device, and a processor. The image forming device forms an image on a sheet on the basis of an image forming condition for forming a margin region. The storage device prestores first size information indicating a prescribed size of a first sheet and margin information indicating a margin region provided in the first sheet. The input device inputs second size information indicating a size of a second sheet on which an image is to be formed by the image forming device.

The processor determines, on the basis of the first size information and the second size information, the image forming condition for forming the margin region indicated by the margin information on the second sheet.

### Embodiment

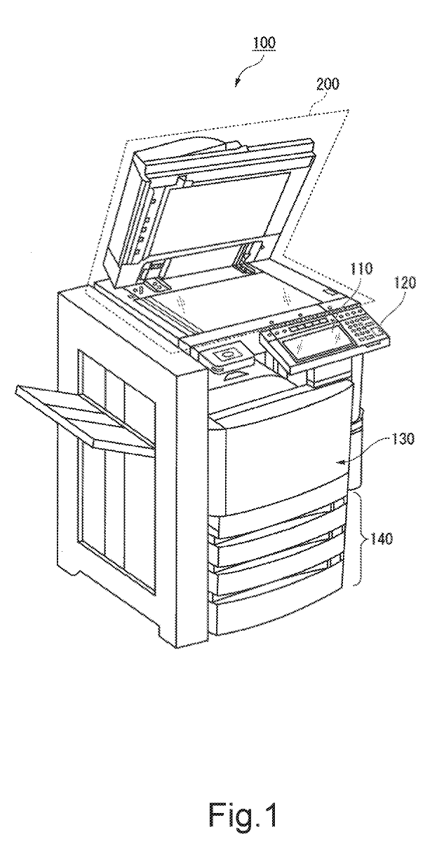

FIG. 1 is an outer appearance view of an entire configuration example of an image forming apparatus 100 according to an embodiment. The image forming apparatus 100 is, for example, a multifunctional machine. The image forming apparatus 100 includes a display 110, an operation panel 120, a printer 130, a sheet housing device 140, and an image reading device 200.

The image forming apparatus 100 uses a developer such as a toner to form an image on a sheet. The sheet is, for example, paper or label paper. Any medium can be used for the sheet as long as it is a medium on which the image forming apparatus 100 is capable of forming images on the surface thereof.

The display 110 is an image display apparatus such as a liquid crystal display and an organic electro luminescence (EL) display. The display 110 displays various types of information regarding the image forming apparatus 100.

The operation panel 120 includes a plurality of buttons. The operation panel 120 receives an operation of a user. The operation panel 120 outputs a signal corresponding to an operation performed by the user to a controller (controller 300 to be described later) of the image forming apparatus 100. It should be noted that the display 110 and the operation panel 120 may be configured as an integrated touch panel.

The printer 130 forms an image on a sheet on the basis of image information generated by the image reading device 200 or image information received via a communication path. The printer 130 forms an image by, for example, processing to be described below. An image forming device 131 of the printer 130 forms an electrostatic latent image on a photosensitive drum on the basis of the image information. The image forming device 131 of the printer 130 causes the developer to adhere to the electrostatic latent image to form a visible image. The printer 130 uses a toner as the developer and forms a toner image as the visible image. A transfer device of the printer 130 transfers a visible image (toner image) to the sheet. A fixing device of the printer 130 heats and presses the sheet to fix the visible image on the sheet. It should be noted that a sheet which is manually fed to the printer 130 from a manual feeding tray (not shown) and a sheet which is automatically fed to the printer 130 from the sheet housing device 140 are both capable of performing a similar image forming operation. Therefore, the sheet on which an image is to be formed may be a sheet housed in the sheet housing device 140 or may be a sheet that is manually fed.

The sheet housing device 140 houses sheets to be used for image formation in the printer 130.

The image reading device 200 reads image information to be read, as brightness and darkness of light. The image reading device 200 stores the read image information. The stored image information may be transmitted to another information processing apparatus via a network. The stored image information may be used to form an image on a sheet by the printer 130.

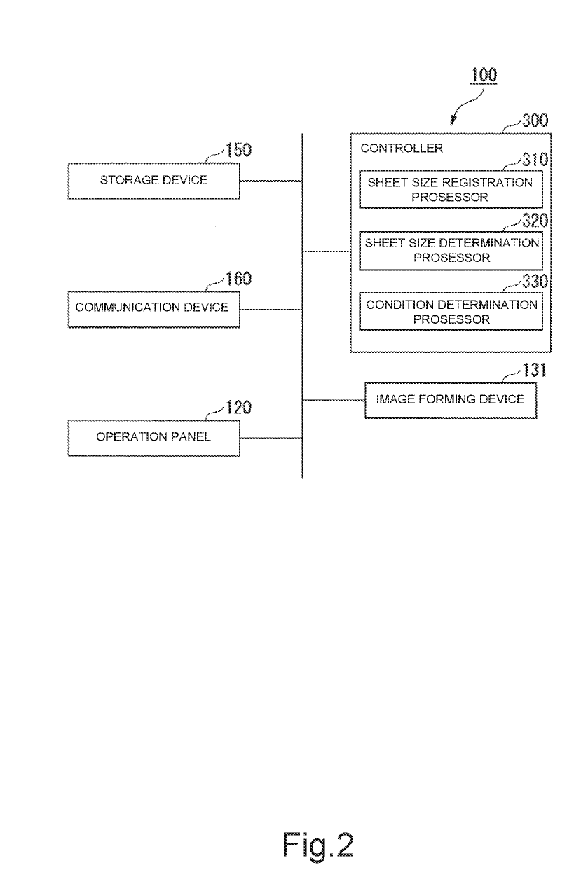

FIG. 2 is a block diagram schematically showing a configuration of functional blocks of the image forming apparatus 100 in the embodiment. The image forming apparatus 100 includes the controller 300. The controller 300 connects to the operation panel 120, the image forming device 131, a storage device 150, a communication device 160, and the image reading device 200 via a data bus, for example.

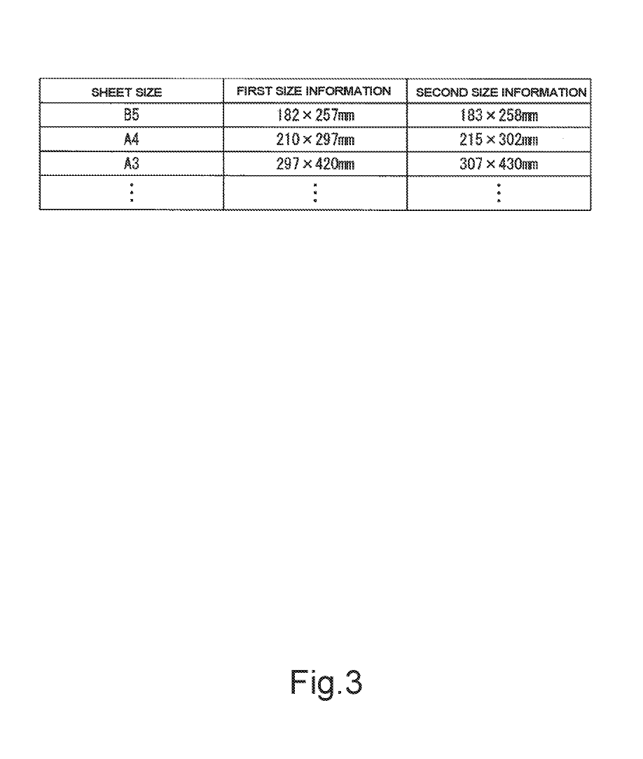

The storage device 150 includes a storage device such as a magnetic hard disk apparatus, a semiconductor storage device, and the like. The storage device 150 prestores first size information and margin information indicating a margin region provided in the first sheet. It should be noted that the first sheet is a sheet to be used in adjustment before shipment of the image forming apparatus 100 (e.g., in test operation of manufacture). Further, the first size information is information indicating a prescribed size of the first sheet. The first size information may be information indicating a prescribed fixed value. The first size information may be information indicating a sheet size of a predetermined standard size of a sheet (first sheet) used in the test operation of manufacture. Specifically, for example, in a case where the sheet whose industrial standard size of the printed matter of the ISO is “A4” is used as the first sheet, the first size information is information indicating the prescribed size “210 mm (width W)×297 mm (length L)” of the sheet of the A4 size. Further, the first size information may be information indicating the size of the first sheet which was measured in adjustment before shipment of the image forming apparatus 100. For example, in a case where the sheet of the A4 size is used as the first sheet, the prescribed size of the sheet of the A4 size is “210 mm (width W)×297 mm (length L)” as described above. In contrast, there is a possibility that the actual size of the sheet (the size of the first sheet which was measured) changes in an adjustment environment (due to temperature, humidity, and the like) of the image forming apparatus 100 in a factory or the like. It should be noted that a method of measuring the size of the first sheet in this case is not limited. It should be noted that in this embodiment, as shown in FIG. 3 to be described later, the storage device 150 stores information indicating the prescribed size of the industrial standard size of the printed matter of the ISO as the first size information. Further, the margin information is specifically information indicating a prescribed size of a margin when an image is formed on the first sheet. More specifically, the margin information is information indicating a prescribed size of a top void, a prescribed size of a left void, a prescribed size of a right void, and a prescribed size of a bottom void. Further, the first size information and the margin information are input by the operation panel 120 which is an input device and are stored in the storage device 150 in adjustment before shipment of the image forming apparatus 100, for example.

The storage device 150 stores second size information notified from a sheet size registration processor 310 of the controller 300 to be described later while associating the second size information with the first size information. Here, the second size information is information indicating a size of a second sheet. The second sheet is a sheet to be actually used for printing by the image forming apparatus 100 in each market which is a shipment destination of the image forming apparatus 100. In other words, the second sheet is a sheet to be used when image formation is performed by the image forming device 131 of the image forming apparatus 100. Further, the size of the second sheet is a measured size of the second sheet, for example. Specifically, for example, in a case where the sheet whose industrial standard size of the printed matter of the ISO is “A4” is used as the second sheet and where the measured size of the sheet of the A4 size is “215 mm (width W)×302 mm (length L)”, the second size information is information indicating the size of the second sheet, “215 mm×302 mm”. Here, as described above, the prescribed size of the sheet of the A4 size is “210 mm×297 mm”. In contrast, there is a possibility that the actual size of the sheet changes as in the measured size in the use environment (due to temperature, humidity, and the like) of the image forming apparatus 100 in the market. That is, the first sheet and the second sheet are sheets of an identical standard size. It should be noted that a method of measuring the size of the second sheet in this embodiment is not limited. Further, the measurement of the size of the second sheet is performed on the sheet of the standard size scheduled to be used by the user in initial adjustment (set-up) of the image forming apparatus 100, for example, in each market. Further, the second size information is input by the operation panel 120 which is the input device, for example, and is stored in the storage device 150. Further, the storage device 150 stores a printing condition determined by a condition determination processor 330 of the controller 300 to be described later. The printing condition herein is the image forming condition of the image forming device 131, which is a base for forming the margin region on the sheet. In other words, the storage device 150 stores the image forming condition determined by the condition determination processor 330.

The controller 300 includes a processor such as a central processing unit (CPU). By the processor executing the program, the controller 300 operates as the sheet size registration processor 310, a sheet size determination processor 320, and the condition determination processor 330. The controller 300 operates as each of those processors 310 to 330 to determine the image forming condition for forming the margin region indicated by the margin information stored in the storage device 150 on the second sheet.

The sheet size registration processor 310 registers, in the storage device 150, the second size information of the second sheet to be actually used for printing. It should be noted that the sheet size registration processor 310 uses an arbitrary sheet to update the first size information in order to change the first size information prestored as the prescribed size in the storage device 150.

The sheet size determination processor 320 determines whether or not the difference between the first size information and the second size information is equal to or smaller than a predetermined threshold on the basis of the margin information stored in the storage device 150, the first size information, and the second size information. That is, as will be described later, the sheet size determination processor 320 calculates a difference between the size of the first sheet which is indicated by the first size information and the size of the second sheet which is indicated by the second size information. Then, the sheet size determination processor 320 determines whether or not the calculated difference is equal to or smaller than the predetermined threshold. It should be noted that it is assumed that in this embodiment, the sheet size determination processor 320 determines the threshold as 2 mm. The threshold of that difference may be arbitrarily set. A specific example (FIG. 3) of determination of the sheet size determination processor 320 will be described later.

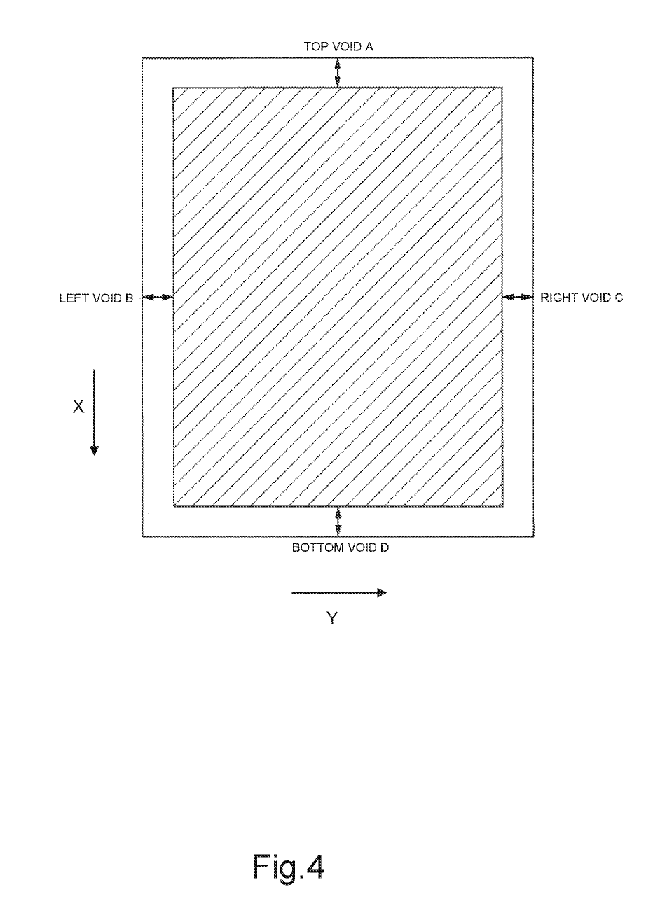

If the calculated difference is above a predetermined threshold as a result of determination of the sheet size determination processor 320, the condition determination processor 330 determines an image forming condition to be changed in printing on the second sheet. For example, the condition determination processor 330 changes the reference position (printing start position) of the image to be printed on the second sheet, at which image formation is to be started. Further, the condition determination processor 330 changes a scaling factor of the image to be printed on the second sheet in a main scan direction. The main scan direction is a direction along a conveying direction of the sheet to be conveyed to the image forming device 131 inside the image forming apparatus 100. Specifically, the main scan direction is an arrow X direction in FIGS. 4 to 8. The condition determination processor 330 changes a scaling factor of the image to be printed on the second sheet in a sub-scan direction. The sub-scan direction is a direction orthogonal to the main scan direction.

The condition determination processor 330 stores, in the storage device 150, a changed condition(s) of the respective image forming conditions including the reference position (printing start position) at which image formation is to be started, the scaling factor in the main scan direction, and the scaling factor in the sub-scan direction. It should be noted that if an image forming condition of the respective image forming conditions was not changed, the condition determination processor 330 stores, in the storage device 150, that image forming condition as it is the condition predetermined at the time of shipment.

FIG. 3 is a diagram showing a data configuration of a sheet size table to be stored in the storage device according to the embodiment. In the sheet size table, the sheet size (kind of sheet) and the first size information are prestored in association with each other. The storage device 150 stores the second size information received from the sheet size registration processor 310 while associating the second size information with the sheet size (kind of sheet) and the first size information.

The sheet size shown in FIG. 3 represents the industrial standard size of the printed matter of the ISO (hereinafter, simply referred to as a standard size), such as A4 and B5. The first size information is the information indicating the size of the first sheet prestored in adjustment before shipment (in manufacture) as described above. The second size information represents a size which is the information indicating the size of the second sheet to be actually used for printing, as described above. It should be noted that in this embodiment, the prescribed size (industrial prescribed size) which is the standard size is used as the first size information as an example.

In the example of FIG. 3 of this embodiment, the sheet size determination processor 320 is set to cope with an input made by a user who mixes up Japanese size (e.g., A3) and American size (e.g., LD). A threshold is determined such that the sheet size determination processor 320 can determine that the input size, which is a wrong size input by the user, has a difference. The threshold is set to 2 mm. On the basis of this threshold, a determination is made as to the sheets of A4 and A3 that the width and the height of the first size information and the second size information have a difference. The sheet size determination processor 320 makes a determination as to the sheet of B5 that there are no differences because the differences of the width and the height between the first size information and the second size information are both equal to or smaller than 2 mm.

FIG. 4 is a diagram showing a prescribed size of a margin to be formed in image formation (i.e., at the time of printing) on the first sheet according to the embodiment. In the following description, the unit (mm) will be omitted. In FIG. 4, the margin is expressed as the prescribed size in image formation on the first sheet. In this embodiment, regarding the margin information indicating the margin region of the size prescribed on the first sheet, as shown in FIGS. 4 to 8, the size (distance) of the top void is “A”, the size (distance) of the left void is “B”, the size (distance) of the right void is “C”, and the size (distance) of the bottom void is “D”.

It should be noted that in FIGS. 4 to 8, the sheet conveying direction is a direction from the bottom void to the top void. That is, the image to be formed on the sheet starts to be formed from the top void in a main scan direction X of the image. Further, the image to be formed on the sheet starts to be formed from the left void in a sub-scan direction Y. Further, in FIGS. 4 to 8, the oblique line portion is a portion in which the image is to be formed.

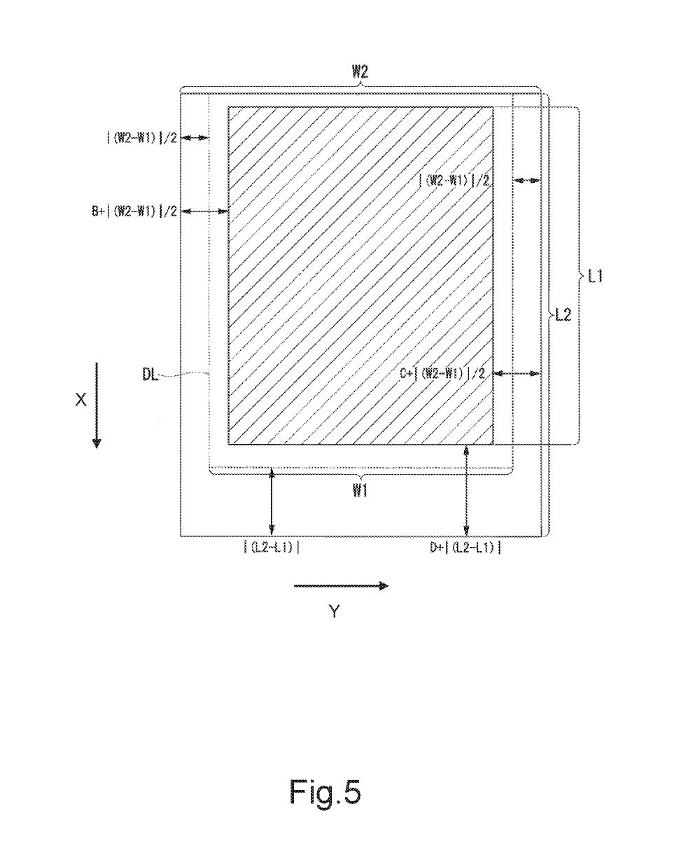

FIG. 5 is a diagram showing the size of the margin to be formed in image formation on the second sheet according to the embodiment. In FIG. 5, the dotted line DL indicates the size of the first sheet. It should be noted that although the second sheet is larger than the first sheet in this embodiment to be described below, the first sheet may be larger than the second sheet. Furthermore, in this embodiment to be described below, the sheet size handled by the image forming apparatus 100 is used assuming that the size of the first sheet in the main scan direction is a width W1, the size of the first sheet in the sub-scan direction is a height L1, the size of the second sheet in the main scan direction is a width W2, and the size of the second sheet in the sub-scan direction is a height L2.

In the case of FIG. 5, a difference between the first size information and the second size information is calculated. Firstly, the sheet size registration processor 310 stores the first size information and the second size information in the storage device 150 and then aligns the width W1 and the width W2 such that the centers of the width W1 and the width W2 overlap each other.

Next, the sheet size determination processor 320 calculates a size difference between the first sheet and the second sheet on the basis of the overlapping processing performed by the sheet size registration processor 310, the first size information, and the second size information.

the sheet size determination processor 320 calculates a left edge distance between a left edge of the second sheet and a left edge of the first sheet and a right edge distance between a right edge of the second sheet and a right edge of the first sheet in accordance with Expression (1) below. The sheet size determination processor 320 calculates a difference between the first sheet and the second sheet in the main scan direction, that is, the sum of the left edge distance and the right edge distance.

Firstly, in order to determine a difference of the length in the main scan direction, the sheet size determination processor 320 compares the width W1 which is the length of the first sheet in the main scan direction with the length of the second sheet in the main scan direction which is the width W2. At this time, the sheet size determination processor 320 determines an absolute value of the difference between the width W1 and the width W2 as a condition for establishing Expression (1) irrespective of which of the first sheet and the second sheet is larger than the other one.

The width W1 and the width W2 have the centers overlapping each other. Therefore, the sheet size determination processor 320 can determine Diff1 indicating the left edge distance and the right edge distance by halving the difference between the width W1 and the width W2. In the above-mentioned manner, Diff1 indicating the left edge distance and the right edge distance can be expressed as Expression (1).

[Expression 1]

Diff1=|W2−W1|/2 (1)

Diff2 indicating a distance between the left edge of the second sheet and a left edge of the image to be formed on the first sheet includes the size “B” of the left void of the first sheet. Therefore, Diff2 can be determined by adding the size “B” of the left void to Expression (1) above. Thus, Diff2 can be expressed as Expression (2) below.

[Expression 2]

Diff2=B+|W2−W1|/2 (2)

Diff3 indicating a distance between the right edge of the second sheet and a right edge of the image to be formed on the first sheet includes the size “C” of the right void of the first sheet. Therefore, Diff3 can be determined by adding the size “C” of the right void to Expression (1) above. Thus, Diff3 is expressed as Expression (3) below.

[Expression 3]

Diff3=C+|W2−W1|/2 (3)

The sheet size determination processor 320 determines a length difference in the sub-scan direction in accordance with Expression (4) below. Therefore, the sheet size determination processor 320 calculates Diff4 indicating a lower edge distance between a lower edge of the second sheet and a lower edge of the first sheet.

Firstly, the sheet size determination processor 320 compares the height L1 which is the length of the first sheet in the sub-scan direction with the height L2 which is the length of the second sheet in the sub-scan direction. At this time, the sheet size determination processor 320 determines an absolute value of a difference between the height L1 and the height L2 as a condition for establishing Expression (4) irrespective of which of the first sheet and the second sheet is larger than the other one.

[Expression 4]

Diff4=|L2−L1| (4)

Diff5 indicating a distance between the lower edge of the second sheet and a lower edge of the image to be formed on the first sheet includes the size “D” of the bottom void of the first sheet. Therefore, Diff5 can be determined by adding the size “D” of the bottom void to Expression (4) above. Thus, Diff5 is expressed as Expression (5) below.

[Expression 5]

Diff5=D+|L2−L1| (5)

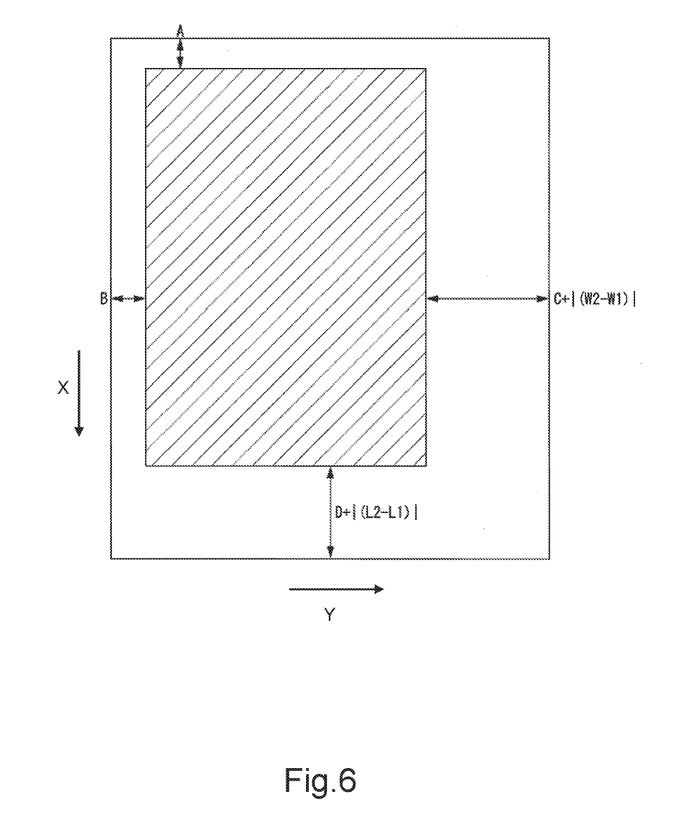

FIG. 6 is a diagram showing an image formed by correcting the reference position at which image formation is to be started in image formation on the second sheet according to the embodiment. The condition determination processor 330 determines a reference position at which image formation is to be started on the image to be formed on the second sheet on the basis of the margin information of the first sheet which is prestored in the storage device 150. In FIG. 6, the size of the top void of the margin information is “A” and the size (distance) of the left void is “B”. Therefore, the condition determination processor 330 determines the reference position at which image formation is to be started, which is a position moved from an upper edge of the second sheet by the size “A” and moved from the left edge by the size “B”, as the first image forming condition.

The oblique line portion of FIG. 6 is an image formed by the image forming device 131 on the basis of the first image forming condition. In FIG. 6, the reference position at which image formation is to be started has been determined on the basis of the margin information. Therefore, the size of the top void is set to “A” and the size of the left void is set to “B”. At this time, the size of the right void is still “C+|(W2−W1)|/2” without changes. Further, the size of the bottom void is still “L+|(L2−L1)|/2” without changes.

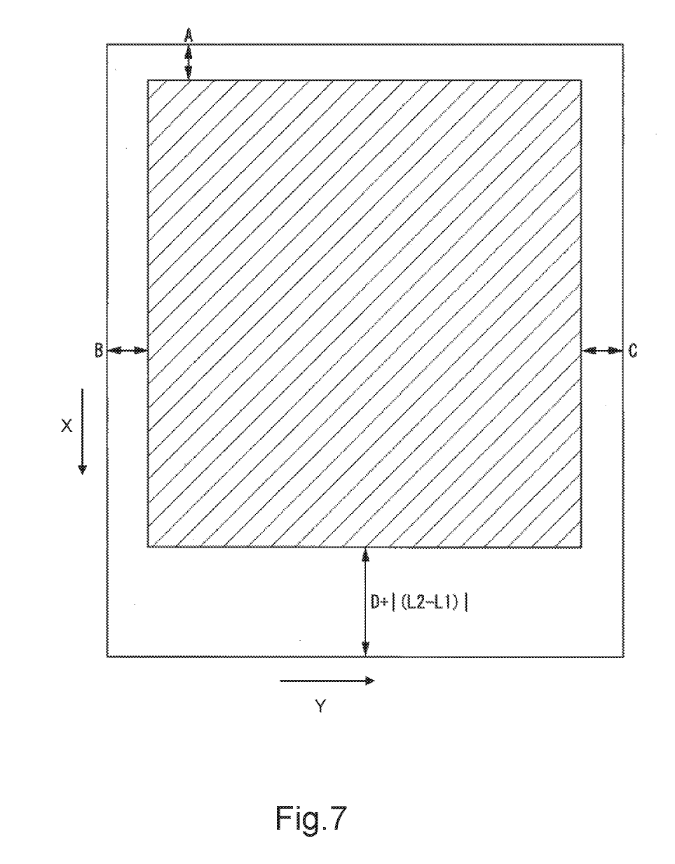

FIG. 7 is a diagram showing an image formed by correcting a scaling factor in the main scan direction X in image formation on the second sheet according to the embodiment. The condition determination processor 330 determines a scaling factor in the main scan direction on the basis of the margin information of the first sheet which is prestored in the storage device 150. In FIG. 7, the size of the right void of the margin information is “C”. Therefore, the condition determination processor 330 determines the determined scaling factor in the main scan direction as the second image forming condition.

The oblique line portion of FIG. 7 is an image formed by the image forming device 131 on the basis of the first image forming condition and the second image forming condition. In FIG. 7, the reference position at which image formation is to be started has been determined on the basis of the margin information. Therefore, the size of the top void is set to “A” and the size of the left void is set to “B”. Next, the scaling factor in the main scan direction has been determined. Therefore, the size of the right void is set to “C”. The size of the bottom void is still “L+|(L2−L1)|/2” without changes.

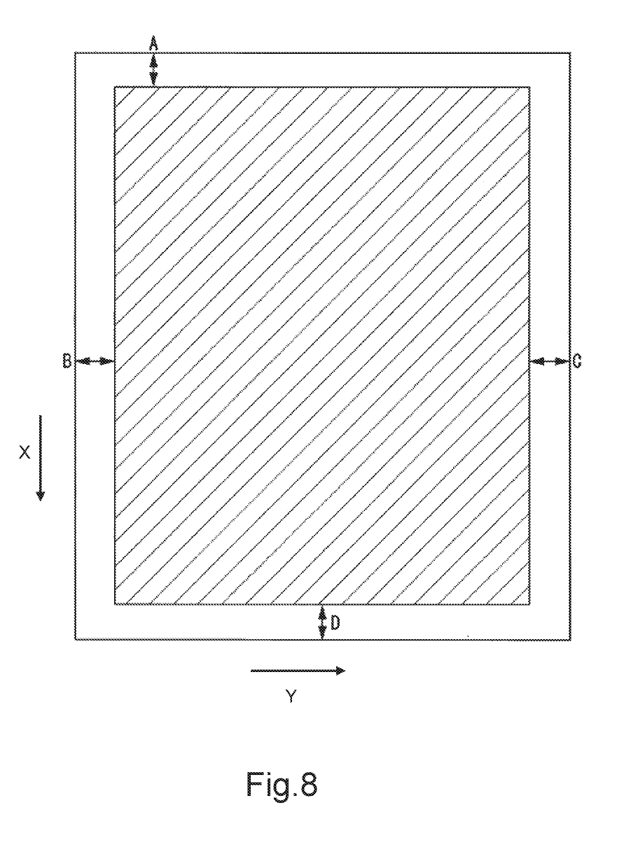

FIG. 8 is a diagram showing an image formed by correcting the scaling factor in the sub-scan direction in image formation on the second sheet according to the embodiment. The condition determination processor 330 determines a scaling factor in the sub-scan direction on the basis of the margin information of the first sheet which is prestored in the storage device 150. In FIG. 8, the size of the bottom void of the margin information is “D”. Therefore, the condition determination processor 330 determines the determined scaling factor in the sub-scan direction as a third image forming condition.

The oblique line portion of FIG. 8 is an image formed by the image forming device 131 on the basis of the first image forming condition, the second image forming condition, and the third image forming condition. In FIG. 8, the reference position at which image formation is to be started has been determined on the basis of the margin information. Therefore, the size of the top void is set to “A” and the size of the left void is set to “B”. Next, the scaling factor in the main scan direction has been determined. Therefore, the size of the right void is set to “C”. Lastly, the scaling factor in the sub-scan direction has been determined. Therefore, the size of the bottom void is set to “D”.

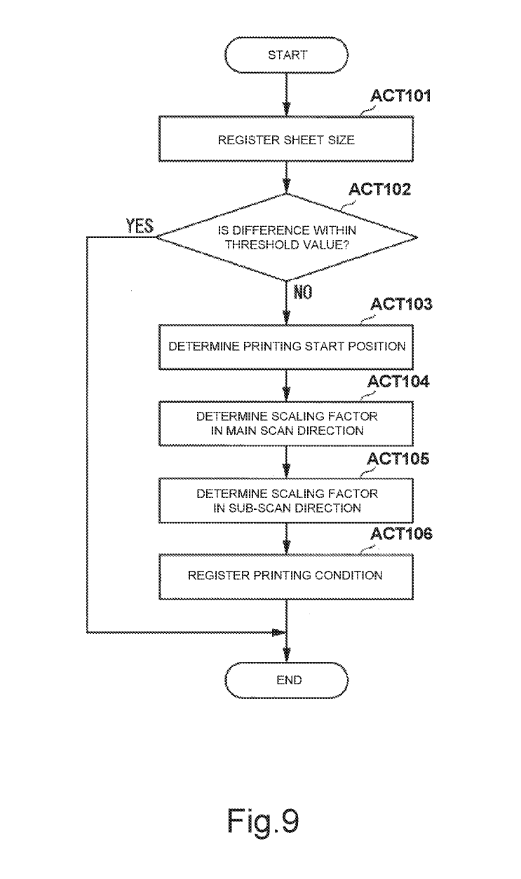

FIG. 9 is a flowchart showing a specific example of determination processing for an image forming condition, which is performed by each of the processors 310 to 330 of the controller 300. It should be noted that the processing to be described below is performed in initial adjustment (set-up) of the image forming apparatus 100, for example, in each market. Therefore, the first size information and the margin information is prestored in the storage device 150. Firstly, in ACT101, the sheet size registration processor 310 registers, in the storage device 150, second size information indicating a size of a second sheet. Specifically, the second size information is input by the operation panel 120, for example. The sheet size registration processor 310 stores the input second size information in the storage device. Next, the sheet size registration processor 310 acquires the first size information of the first sheet and the second size information of the second sheet for each sheet of an identical standard size (e.g., the A4 size or the like). In ACT102, the sheet size determination processor 320 determines whether or not the difference between the first size information and the second size information is equal to or smaller than the predetermined threshold on the basis of the margin information, the first size information, and the second size information.

If the difference between the first size information and the second size information is equal to or smaller than the predetermined threshold (ACT102: YES), the processor of the controller 300 terminates the processing. On the other hand, if the difference is not equal to or smaller than the predetermined threshold (ACT102: NO), the processing of the processor of the controller 300 proceeds to ACT103. In ACT103, the condition determination processor 330 determines the reference position at which image formation is to be started on the image to be formed on the second sheet as the first image forming condition.

Next, in ACT104, the condition determination processor 330 determines the scaling factor in the main scan direction as the second image forming condition on the basis of the margin information, the first size information, and the second size. Next, in ACT105, the condition determination processor 330 determines the scaling factor in the sub-scan direction as the third image forming condition on the basis of the margin information, the first size information, and the second size. In ACT106, the condition determination processor 330 registers the first image forming condition, the second image forming condition, and the third image forming condition in the storage device 150.

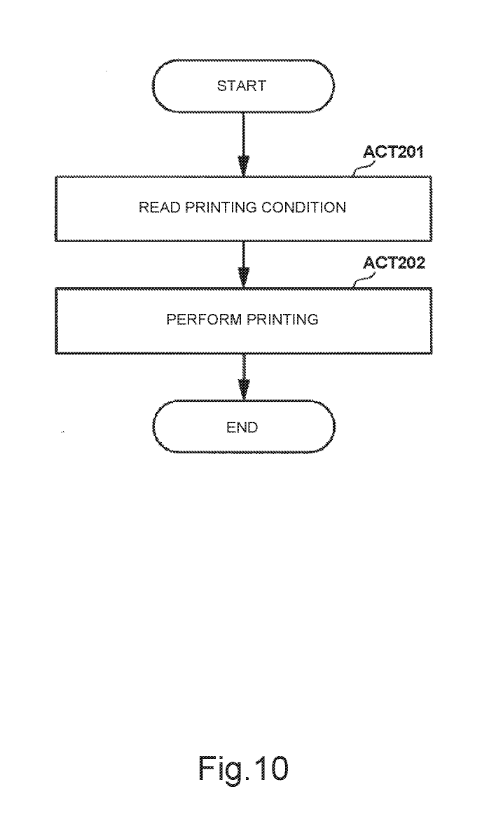

FIG. 10 is a flowchart showing a specific example of printing processing performed by the controller 300 of the image forming apparatus 100. When the printing is performed, in ACT201, the image forming device 131 reads the image forming conditions from the storage device 150. In ACT202, the image forming device 131 performs printing on the basis of the read image forming conditions.

In accordance with the thus configured image forming apparatus 100, the printing conditions are determined such that the margin information stored in the storage device 150 is formed on the second sheet on the basis of the margin information stored in the storage device 150, the first size information, and the second size information. Therefore, a deviation between the margin prescribed in the manufacturing process and the margin to be formed at the time of printing in the market can be reduced.

In accordance with at least one embodiment described above, the deviation between the margin prescribed in the manufacturing process and the margin to be formed at the time of printing in the market can be reduced.

At least some of the functions of the image forming apparatus 100 in the embodiment described above may be achieved by a computer. In such a case, a program for achieving those functions may be recorded in a computer-readable recording medium. Further, the functions of the image forming apparatus 100 may be achieved by causing a computer system to read and execute the program recorded in that recording medium. It should be noted that the “computer system” herein includes the OS and hardware such as peripherals. Further, the “computer-readable recording medium” means a storage device such as a hard disk incorporated into the computer system. The storage device also includes a portable medium such as a flexible disk, a magneto-optical disk, a ROM, or a CD-ROM, DVD-ROM, and a USB memory. Furthermore, the “computer-readable recording medium” may be a medium that dynamically holds a program for a short period of time.

Specifically, the one that dynamically holds the program includes a network such as the Internet, communication wires used when a program is transmitted via a communication line such as a telephone line, and the like.

Further, the “computer-readable recording medium” may include a medium that holds a program for a certain period of time.

Specifically, the computer-readable recording medium includes a volatile memory or the like inside a computer system serving as a server or a client.

Further, the program described above may be a program for achieving some of the above-mentioned functions.

Furthermore, the program described above may be a program capable of achieving the above-mentioned functions in combination with programs already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image forming device that forms an image on a sheet on a basis of an image forming condition for forming a margin region;
a storage device that prestores
first size information indicating a prescribed size of a first sheet and
margin information indicating a margin region provided in the first sheet;
an input device that inputs second size information indicating a size of a second sheet on which an image is to be formed by the image forming device; and
a processor configured to determine, on a basis of the first size information and the second size information, the image forming condition for forming the margin region indicated by the margin information on the second sheet.

2. The image forming apparatus according to claim 1, wherein
the first sheet and the second sheet are sheets of an identical standard size,
the first sheet is a sheet to be used in adjustment before shipment of the image forming apparatus, and
the second sheet is a sheet to be used in image formation in each market after shipment of the image forming apparatus.

3. The image forming apparatus according to claim 2, wherein
the processor is configured to compare the size of the first sheet which is indicated by the first size information with the size of the second sheet which is indicated by the second size information and determine whether or not a difference between the size of the first sheet and the size of the second sheet is equal to or smaller than a threshold.

4. The image forming apparatus according to claim 1, wherein
the processor is configured to determine
a reference position at which image formation is to be started on the second sheet,
a scaling factor in a main scan direction of the image to be formed, and
a scaling factor of the image to be formed in a sub-scan direction, as the image forming condition on a basis of a result of determination as to the difference between the size of the first sheet and the size of the second sheet.

5. The image forming apparatus according to claim 1, wherein
the storage device stores the image forming condition determined by the processor, and
the image forming device forms, in a case where the image forming condition is stored in the storage device, an image on the second sheet on a basis of the stored image forming condition.

6. An image forming method for an image forming apparatus including an image forming device that forms an image on a sheet, comprising:
prestoring in a storage device
first size information indicating a prescribed size of a first sheet and
margin information indicating a margin region provided in the first sheet;
inputting second size information indicating a size of a second sheet which is used in a case where image formation is performed by the image forming device;
determining, on a basis of the first size information and the second size information, the image forming condition for forming the margin region indicated by the margin information on the second sheet; and
forming, by the image forming device, an image on the second sheet on a basis of the image forming condition.

7. The image forming method according to claim 6, wherein
the first sheet and the second sheet are sheets of an identical standard size,
the first sheet is a sheet to be used in adjustment before shipment of the image forming apparatus, and
the second sheet is a sheet to be used in image formation in each market after shipment of the image forming apparatus.

8. The image forming method according to claim 7, wherein
the determining of the image forming condition includes comparing the size of the first sheet which is indicated by the first size information with the size of the second sheet which is indicated by the second size information and determining whether or not a difference between the size of the first sheet and the size of the second sheet is equal to or smaller than a threshold.

9. The image forming method according to claim 6, wherein
the determining of the image forming condition includes determining
a reference position at which image formation is to be started on the second sheet,
a scaling factor of the image to be formed in a main scan direction, and
a scaling factor of the image to be formed in a sub-scan direction, as the image forming condition on a basis of a result of determination as to a difference between the size of the first sheet and the size of the second sheet.

10. The image forming method according to claim 6, further comprising
storing the image forming condition determined by the determining of the image forming condition, wherein the forming of the image includes forming an image on the second sheet on a basis of the image forming condition stored in the storage device.
